(19) United States
(12) Patent Application Publication
(10) Pub. No.: US 2009/0297151 A1
(43) Pub. Date: Dec. 3, 2009

(54) Optical transmitting apparatus and optical transmitting and receiving apparatus

(75) Inventors: Mitsuo Yoneda, Fukuoka (JP); Masanori Eiro, Fukuoka (JP); Tomoyuki Sakata, Fukuoka (JP); Takaaki Itose, Fukuoka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/320,898

(22) Filed: Feb. 6, 2009

(30) Foreign Application Priority Data
Jun. 2, 2008 (JP) 2008-144771

(51) Int. Cl. H04J 14/02

(52) U.S. Cl. 398/79

(57) ABSTRACT

An optical transmitting apparatus includes an unused-wavelength determining unit. The unused-wavelength determining unit monitors the wavelength of the optical signal transmitted by transmitting apparatuses to determine an unused wavelength currently not in use. The transmitting apparatuses contain a stopping unit that stops transmitting the optical signal when no signal is input, an unused-wavelength obtaining unit that obtains the unused wavelength determined by the unused-wavelength determining unit after the optical signal transmission is stopped and is then restarted, and a transmitting unit that converts a new signal to an optical signal of the unused wavelength obtained by the unused-wavelength obtaining unit to transmit the optical signal to the receiving apparatus.

### CROSS-REFERENCE TO RELATED APPLICATION

This application is based upon and claims the benefit of priority of the prior Japanese Patent Application No. 2008-144771, filed on Jun. 2, 2008, the entire contents of which are incorporated herein by reference.

### FIELD

The embodiments discussed herein are directed to an optical transmitting apparatus and optical transmitting and receiving apparatus.

### BACKGROUND

Conventionally, for construction of an optical communication network, a Wavelength Division Multiplexing (WDM) system is often used for the purpose of increasing the transmission capacity per optical fiber cable (for example, Japanese Laid-open Patent Publication No. 2003-324456). The WDM system multiplexes optical signals of different wavelengths on a single optical fiber cable for transmission.

A WDM apparatus for use in a WDM system generally includes, as depicted in FIG. 8, a plurality of transmitting and receiving apparatuses, a wavelength multiplexing unit (combiner, multiplexer), and a wavelength demultiplexing unit (demultiplexer). The transmitting and receiving apparatuses each convert a wideband wavelength signal input from an external apparatus, such as a router, to a narrowband wavelength signal. The wavelength multiplexing unit multiplexes (combines) the optical signals input from the transmitting and receiving apparatuses for transmission to an optical fiber cable. The wavelength demultiplexing unit demultiplexes (separates) the optical signal input from the optical fiber cable for each wavelength for output to other transmitting and receiving apparatuses. FIG. 8 is a drawing for explaining a conventional WDM system.

In such a WDM system, the WDM apparatus always transmits and receives optical signals among specific transmitting and receiving apparatuses. Specifically, the wavelength of optical signals to be converted by each transmitting and receiving apparatus is fixed. The wavelength of optical signals to be received by each transmitting and receiving apparatus is also fixed. For example, a transmitting and receiving apparatus that outputs an optical signal of a wavelength λ1 transmits and receives optical signals to and from only another transmitting and receiving apparatus that outputs and optical signal of the wavelength λ1. In other words, an external apparatus connected to the transmitting and receiving apparatus that receives an optical signal of the wavelength λ1 can transmit signals only to an external apparatus connected to a transmitting and receiving apparatus that receives an optical signal of the wavelength λ1.

Meanwhile, in the conventional technology, there is a problem in which a single transmitting and receiving apparatus cannot flexibly support a plurality of wavelengths.

Specifically, in recent years, with the configuration of a network becoming more diversified and complicated, the number of external apparatuses connected to a transmitting and receiving apparatuses increases. With this, signal transmission and reception becomes not restricted to be only between external apparatuses connected to specific transmitting and receiving apparatuses, and the need for transmitting signals to external apparatuses connected to other transmitting and receiving apparatus intensifies. However, the conventional technology cannot satisfy this need.

Moreover, with the configuration of a network becoming more diversified and complicated, the number of opportunities to newly connect an external apparatus to a transmitting and receiving apparatus and to change the configuration of a network increases. To address this situation, however, in the conventional technology, a transmitting and receiving apparatus set with a new wavelength has to be added, because specific transmitting and receiving apparatuses are connected to each other for each wavelength.

### SUMMARY

According to an aspect of the invention, an optical transmitting apparatus includes a plurality of transmitting apparatuses. The transmitting apparatuses each convert an external signal to an optical signal of a predetermined wavelength to be transmitted to a receiving apparatus. The optical transmitting apparatus includes an unused-wavelength determining unit that monitors the wavelength of the optical signal transmitted by each of the transmitting apparatuses to determine an unused wavelength currently not in use by any of the transmitting apparatuses. Each of the transmitting apparatuses includes a stopping unit that stops transmitting the optical signal when no signal to be transmitted to the receiving apparatus is input; an unused-wavelength obtaining unit that obtains the unused wavelength determined by the unused-wavelength determining unit, after the optical signal transmission is stopped by the stopping unit and is then restarted with a newly input external signal; and a transmitting unit that converts the new external signal to an optical signal of the unused wavelength obtained by the unused-wavelength obtaining unit to transmit the optical signal to the receiving apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a drawing for explaining a general outline of a WDM system in a first embodiment;

FIG. 2 is a block diagram of an entire configuration of the WDM system in the first embodiment;

FIG. 3 is a block diagram of the configuration of the WDM system in the first embodiment;

FIG. 4 is a block diagram of the configuration of the WDM system in the first embodiment;

FIG. 5A is a flowchart of a procedure of a process of the WDM system in the first embodiment;

FIG. 5B is a flowchart of the procedure of the process of the WDM system in the first embodiment;

FIG. 5C is a flowchart of the procedure of the process of the WDM system in the first embodiment;

FIG. 6 is a drawing for explaining token data and response data;

FIG. 7 is a drawing for explaining token data and response data; and

FIG. 8 is a drawing for explaining a conventional WDM system.

### DESCRIPTION OF EMBODIMENTS

With reference to the attached drawings, embodiments of the optical transmitting apparatus and optical transmitting and receiving apparatus according to the present invention are explained in detail below. In the following, a WDM system including the optical transmitting apparatus and optical transmitting and receiving apparatus according to the present invention (hereinafter, also referred to as a WDM apparatus) is explained as an embodiment. In the following, to clarify the principle of a WDM system according to a first embodiment, a conventional WDM system is first explained. Next, a general outline of the WDM system according to the first embodiment is explained. Then, the configuration, process procedure, and effects of the first embodiment are explained. Finally, other embodiments are explained.

[Conventional WDM System]

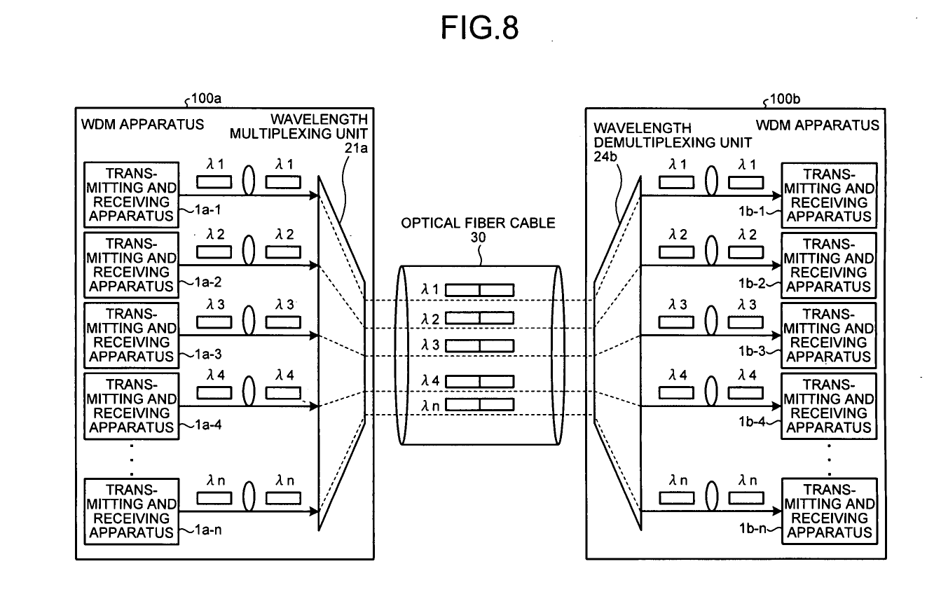

First, an example of the conventional WDM system is explained by using FIG. 8. As depicted in FIG. 8, the conventional WDM system has a WDM apparatus 100a and a WDM apparatus 100b connected to each other via an optical fiber cable 30. Here, an example of transmitting an optical signal from the WDM apparatus 100a to the WDM apparatus 100b is explained. Therefore, although only necessary components are depicted in FIG. 8 for convenience of explanation, the WDM apparatuses 100a and 100b generally have similar functions and configuration.

As depicted in FIG. 8, the WDM apparatus 100a includes a plurality of transmitting and receiving apparatuses 1a-1 to 1a-n and a wavelength multiplexing unit 21a. The WDM apparatus 100b includes a plurality of transmitting and receiving apparatuses 1b-1 to 1b-n and a wavelength demultiplexing unit 24b.

The transmitting and receiving apparatuses 1a-1 to 1a-n of the WDM apparatus 100a have connected thereto an external apparatus not shown (for example, a relaying apparatus, such as a router or switch), converting a signal of a wideband wavelength input from the external apparatus to an optical signal of a predetermined narrowband wavelength set in advance for output to the wavelength multiplexing unit 21a.

The predetermined narrowband wavelength set in advance to the transmitting and receiving apparatuses 1a-1 to 1a-n varies among the transmitting and receiving apparatuses 1a-1 to 1a-n. For example, the transmitting and receiving apparatuses 1a-1 converts a signal-input from the external apparatus to an optical signal of the wavelength λ1. The transmitting and receiving apparatuses 1a-2 converts a signal input from the external apparatus to an optical signal of a wavelength λ2. The transmitting and receiving apparatuses 1a-n converts a signal input from the external apparatus to an optical signal of a wavelength λn.

The wavelength multiplexing unit 21a multiplexes the optical signals of the wavelengths λ1 to λn input from the transmitting and receiving apparatuses 1a-1 to 1a-n for transmission via the optical fiber cable 30 to the wavelength demultiplexing unit 24b of the WDM apparatus 100b.

The wavelength demultiplexing unit 24b demultiplexes the multiplexed optical signal to optical signals of the wavelengths λ1 to λn for output to the transmitting and receiving apparatuses 1b-1 to 1b-n. For example, the wavelength demultiplexing unit 24b outputs the optical signal of the wavelength λ1 from among the optical signals obtained through demultiplexing to the transmitting and receiving apparatus 1b-1. Also, the wavelength demultiplexing unit 24b outputs the optical signal of the wavelength λ2 to the transmitting and receiving apparatus 1b-2. Furthermore, the wavelength demultiplexing unit 24b outputs the optical signal of the wavelength λn to the transmitting and receiving apparatus 1b-n. The transmitting and receiving apparatuses 1b-1 to 1b-n each convert the optical signal input from the wavelength demultiplexing unit 24b to a signal of a wideband wavelength for transmission to the external apparatus not shown.

In this manner, the conventional WDM system performs a process of transmitting optical signals only between specific transmitting and receiving apparatuses. For example, in the WDM system depicted in FIG. 8, a signal input from the external apparatus to the transmitting and receiving apparatus 1a-1 is transmitted only to the transmitting and receiving apparatus 1b-1. That is, the wavelength λ1 is a dedicated wavelength for transmitting optical signals between the transmitting and receiving apparatuses 1a-1 and 1b-1. Similarly, a signal input from the external apparatus to the transmitting and receiving apparatus 1a-2 is transmitted only to the transmitting and receiving apparatus 1b-2. That is, the wavelength λ2 is a dedicated wavelength for transmitting optical signals between the transmitting and receiving apparatuses 1a-2 and 1b-2. Similarly, a signal input from the external apparatus to the transmitting and receiving apparatus 1a-n is transmitted only to the transmitting and receiving apparatus 1b-n. That is, the wavelength λn is a dedicated wavelength for transmitting optical signals between the transmitting and receiving apparatuses 1a-n and 1b-n.

### First Embodiment

### General Outline of the WDM System According to the First Embodiment

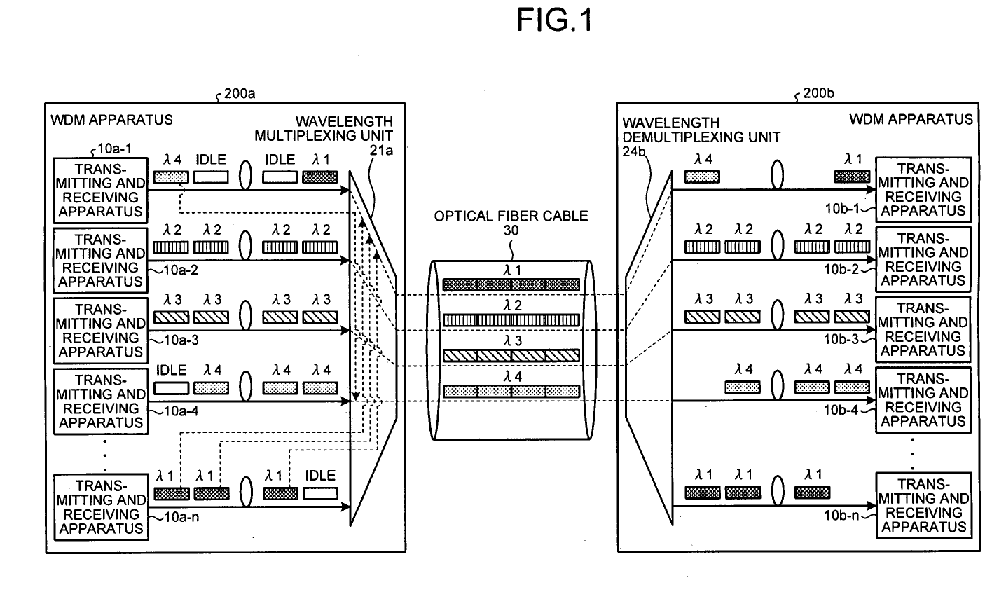

Next, a general outline of the WDM system according to the first embodiment is explained by using FIG. 1. FIG. 1 is a drawing for explaining the general outline of the WDM system in the first embodiment.

For explanation of the general outline of the WDM system according to the first embodiment, first, a WDM apparatus monitors the wavelength of each optical signal to be transmitted from a plurality of transmitting and receiving apparatuses, and determines an unused wavelength currently not in use by any of the transmitting and receiving apparatuses. When no signal to be transmitted to a counterpart transmitting and receiving apparatus is input, the transmitting and receiving apparatuses each stop optical signal transmission. Also, when optical signal transmission is stopped and is then restarted with a newly input signal, the transmitting and receiving apparatuses each obtain the unused wavelength determined in the WDM apparatus. Then, the transmitting and receiving apparatuses each convert a signal to be transmitted to a receiving apparatus to an optical signal of the obtained unused wavelength for transmission to the counterpart transmitting and receiving apparatus.

An example is explained by using FIG. 1 in which an optical signal is transmitted from a WDM apparatus 200a to a WDM apparatus 200b. Although only necessary components are depicted in FIG. 1 for convenience of explanation, the WDM apparatuses 200a and 200b have generally have similar functions and configuration.

As depicted in FIG. 1, the WDM apparatuses 200a in the first embodiment includes a plurality of transmitting and receiving apparatuses 10a-1 to 10a-n and the wavelength multiplexing unit 21a. Also, the WDM apparatus 200b includes a plurality of transmitting and receiving apparatuses 10b-1 to 10b-n and the wavelength demultiplexing unit 24b. In the following, an example is explained in which an optical signal is input from an external apparatus to the WDM apparatus 200a. Alternatively, an electrical signal may be input to the WDM apparatus 200a.

The WDM apparatus 200a monitors the wavelength of each optical signal to be transmitted from each of the transmitting and receiving apparatuses, and determines an unused wavelength currently not in use by any of the transmitting and receiving apparatuses. Also, the transmitting and receiving apparatuses 10a-1 to 10a-n of the WDM apparatus 200a each convert an optical signal of a wideband wavelength input from the external apparatus to an optical signal of a narrowband wavelength, and outputs the optical signal after wavelength conversion to the wavelength multiplexing unit 21a. The transmitting and receiving apparatuses 10a-1 to 10a-n are different from the conventional transmitting and receiving apparatuses 1a-1 to 1a-n depicted in FIG. 8 in that they convert an optical signal input from the external apparatus to not an optical signal of a fixed wavelength but an optical signal of a wavelength dynamically set. As a result, the transmitting and receiving apparatuses 10a-1 to 10a-n can perform conversion to optical signals of a plurality of wavelengths.

Specifically, the transmitting and receiving apparatuses 10a-1 to 10a-n determine a transmission-destination transmitting and receiving apparatus (any one of the transmitting and receiving apparatuses 10b-1 to 10b-n) based on destination information of the optical signal input from the external apparatus. Also, the transmitting and receiving apparatuses 10a-1 to 10a-n obtain information about the unused wavelength determined in the WDM apparatus 200a to recognize a free wavelength. Then, the transmitting and receiving apparatuses 10a-1 to 10a-n convert the optical signal to be transmitted to an optical signal of the recognized free wavelength, and then transmits the resultant optical signal to the determined transmitting and receiving apparatus.

In the example depicted in FIG. 1, the transmitting and receiving apparatus 10a-n stops optical signal transmission when no optical signal to be transmitted to the counterpart transmitting and receiving apparatus is input (indicated as “idle” in FIG. 1). After optical signal transmission is stopped, the transmitting and receiving apparatus 10a-n restarts optical signal transmission with a newly input optical signal. First, the transmitting and receiving apparatus 10a-n determines a transmission-destination transmitting and receiving apparatus 10b-n based on destination information of the optical signal input from the external apparatus. Also, the transmitting and receiving apparatus 10a-n obtains the information about the unused wavelength determined in the WDM apparatus 200a to recognize a free wavelength λ1. Here, as depicted in FIG. 1, the transmitting and receiving apparatus 10a-1 is in an idle state not using the wavelength λ1.

Then, the transmitting and receiving apparatus 10a-n converts the optical signal to be transmitted to an optical signal of the recognized free wavelength λ1 for transmission to the determined transmitting and receiving apparatus 10b-n. At this time, the transmitting and receiving apparatus 10a-n occupies the wavelength λ1 for transmission.

On the other hand, when no optical signal to be transmitted to the counterpart transmitting and receiving apparatus is input, the transmitting and receiving apparatus 10a-1 stops optical signal transmission (indicated as “idle” in FIG. 1). After optical signal transmission is stopped, the transmitting and receiving apparatus 10a-1 restarts optical signal transmission with a newly input optical signal. First, the transmitting and receiving apparatus 10a-1 determines a transmission-destination transmitting and receiving apparatus 10b-1 based on destination information of the optical signal input from the external apparatus. Also, the transmitting and receiving apparatus 10a-1 obtains the information about the unused wavelength determined in the WDM apparatus 200a to recognize a free wavelength λ4. Here, as depicted in FIG. 1, the transmitting and receiving apparatus 10a-4 is in an idle state not using the wavelength λ4.

Then, the transmitting and receiving apparatus 10a-1 converts the optical signal to be transmitted to an optical signal of the recognized free wavelength λ4 for transmission to the determined transmitting and receiving apparatus 10b-1. At this time, the transmitting and receiving apparatus 10a-1 occupies the wavelength λ4 for transmission.

The wavelength multiplexing unit 21a multiplexes optical signals of wavelengths λ1 to λn input from the transmitting and receiving apparatuses 10a-1 to 10a-n for transmission via the optical fiber cable 30 to the wavelength demultiplexing unit 24b of the WDM apparatus 200b. The wavelength demultiplexing unit 24b demultiplexes the multiplexed optical signal to optical signals of the wavelengths λ1 to λn for output to the transmitting and receiving apparatuses 10b-1 to 10b-n.

In this manner, when an optical signal to be transmitted to a transmitting and receiving apparatus is input from the external apparatus, the transmitting and receiving apparatuses according to the first embodiment recognize the transmission-destination transmitting and receiving apparatus and a wavelength not in use at that time, and then set the same wavelength to both receiving and transmitting apparatuses for transmission by using the free wavelength.

Therefore, in the WDM system in the first embodiment, even when a transmitting and receiving apparatus is newly added, a new wavelength does not have to be provided. A single transmitting and receiving apparatus flexibly supports a plurality of wavelengths, thereby transmitting optical signals to a plurality of transmitting and receiving apparatuses. As a result, when the WDM apparatus in the first embodiment is used, a user can flexibly configure a network without being aware of a transmitting and receiving apparatus to which an external apparatus and a user terminal apparatus are connected.

### Configuration of the WDM System in the First Embodiment

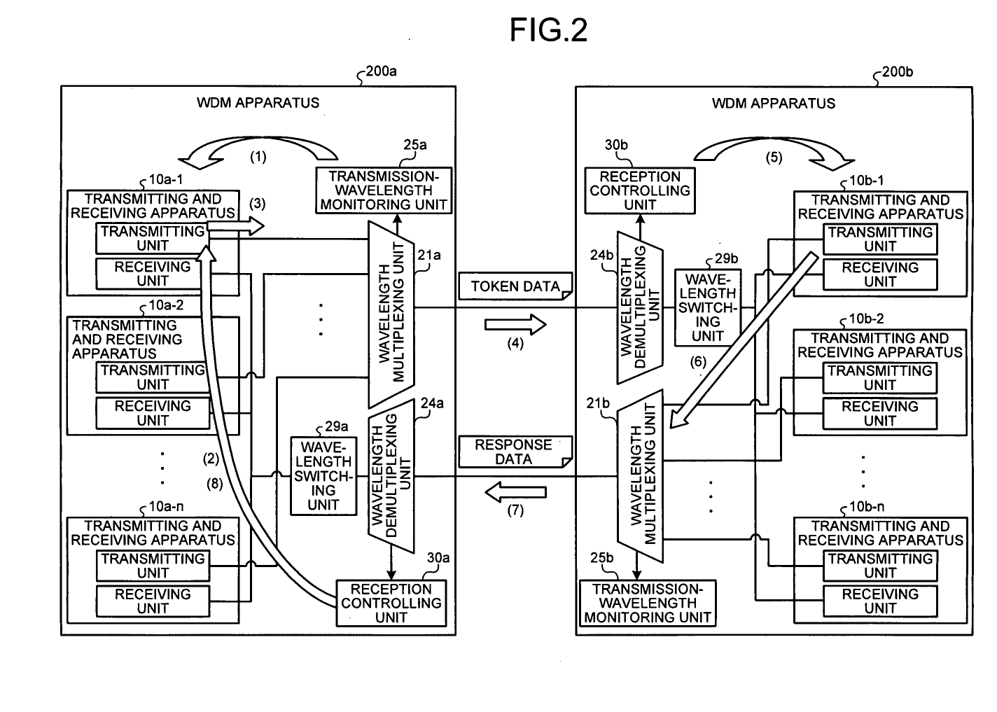

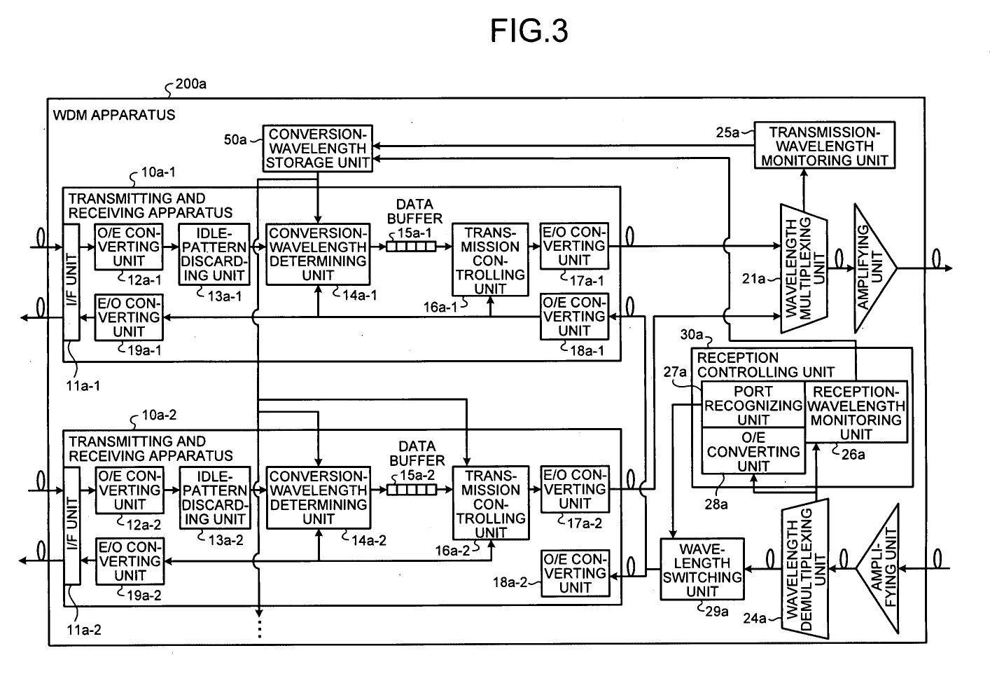

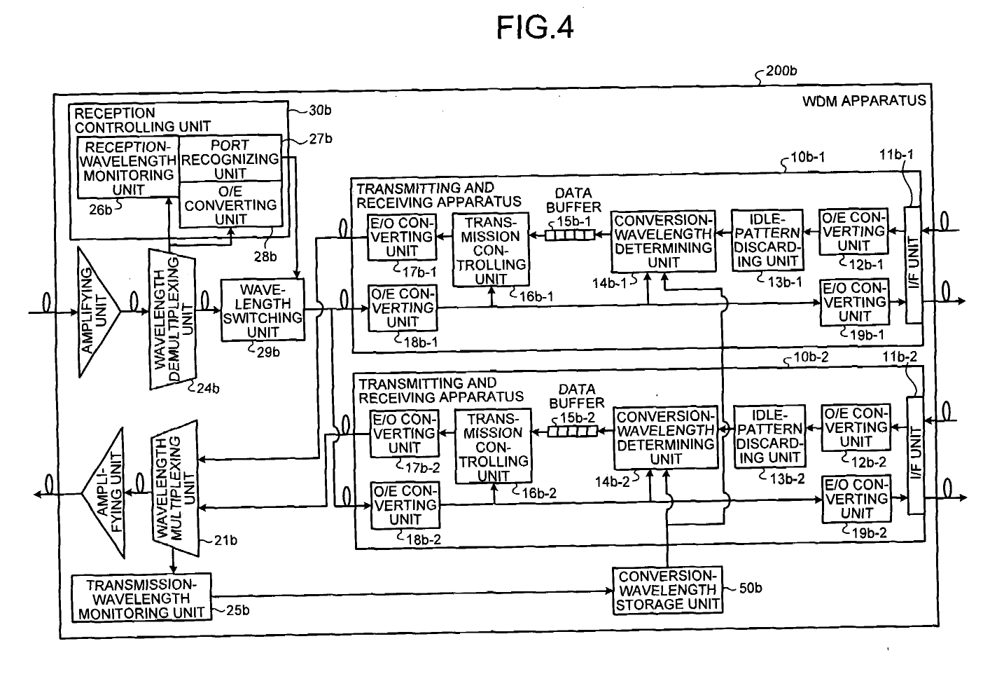

Next, the configuration of the WDM system in the first embodiment is explained by using FIGS. 2 to 4. FIG. 2 is a block diagram of an entire configuration of the WDM system in the first embodiment. FIGS. 3 and 4 are block diagrams of the configuration of the WDM system in the first embodiment.

First, the entire configuration of the WDM system in the first embodiment is explained by using FIG. 2. In FIG. 2, for convenience of explanation, only the general outline of components included in the WDM apparatuses 200a and 200b is depicted. A more detailed configuration of the WDM apparatus 200a is depicted in FIG. 3, whilst a more detailed configuration of the WDM apparatus 200b is depicted in FIG. 4.

As depicted in FIG. 2, in the WDM system in the first embodiment, the WDM apparatuses 200a and 200b having similar functions and configuration are connected together as facing each other. Specifically, an optical signal transmitted via the wavelength multiplexing unit 21a of the WDM apparatus 200a is received by the wavelength demultiplexing unit 24b of the WDM apparatus 200b. Conversely, an optical signal transmitted via a wavelength multiplexing unit 21b of the WDM apparatus 200b is received by a wavelength demultiplexing unit 24a of the WDM apparatus 200a.

Here, in the WDM system in the first embodiment, each transmitting and receiving apparatus exchanges a series of information indicated by (1) to (8) in FIG. 2 when converting an optical signal to be transmitted to a transmission-destination transmitting and receiving apparatus to an optical signal of a free wavelength for transmission. An example is explained in which an optical signal is transmitted from the transmitting and receiving apparatus 10a-1 to the transmitting and receiving apparatus 10a-n.

First, in the WDM apparatus 200a, a transmission-wavelength monitoring unit 25a monitors the wavelength multiplexing unit 21a, thereby monitoring the wavelength of each optical signal to be transmitted from each of the transmitting and receiving apparatuses. Also, the transmission-wavelength monitoring unit 25a reports the monitor result to a conversion-wavelength storage unit 50a shown in FIG. 3. With this, the conversion-wavelength storage unit 50a determines a free wavelength currently not in use by any of the transmitting and receiving apparatuses.

Also, in the WDM apparatus 200a in the first embodiment, not only the transmission-wavelength monitoring unit 25a but also a reception controlling unit 30a monitors the wavelength demultiplexing unit 24a, thereby monitoring the wavelength of each optical signal to be received by each of the transmitting and receiving apparatuses. Also, the reception controlling unit 30a reports the monitor result to the conversion-wavelength storage unit 50a. With this, the conversion-wavelength storage unit 50a determines a free wavelength currently not in use by any of the transmitting and receiving apparatuses.

Meanwhile, it is assumed that the transmitting and receiving apparatus 10a-1, which has stopped optical signal transmission, tries to restart optical signal transmission with a newly input optical signal. First, as indicated by (1) and (2) in FIG. 2, the transmitting and receiving apparatus 10a-1 obtains a free wavelength based on the monitor result obtained through monitoring by the transmission-wavelength monitoring unit 25a and the reception controlling unit 30a. That is, the conversion-wavelength storage unit 50a searches free wavelengths reported from the transmission-wavelength monitoring unit 25a and the reception controlling unit 30a for a free wavelength in both of transmitting and receiving directions, and reports the found free wavelength to the transmitting and receiving apparatus 10a-1. In the following, it is assumed that the free wavelength is λ5.

Then, as indicated by (3) and (4) in FIG. 2, the transmitting and receiving apparatus 10a-1 transmits to the transmitting and receiving apparatus 10b-1 token data reporting that an optical signal of the wavelength λ5 is transmitted.

In the WDM apparatus 200b, the wavelength demultiplexing unit 24b receives the token data. Then, under control of a reception controlling unit 30b and a wavelength switching unit 29b, the token data is received by the transmitting and receiving apparatus 10b-1, as indicated by (5) in FIG. 2.

Then, as indicated by (6) and (7) in FIG. 2, the transmitting and receiving apparatus 10b-1 transmits to the transmitting and receiving apparatus 10a-1 response data responding that the optical signal of the wavelength λ5 reported with the token data can be normally received.

In the WDM apparatus 200a, the wavelength demultiplexing unit 24a receives the response data. Then, under the control of the reception controlling unit 30a and a wavelength switching unit 29a, the response data is received by the transmitting and receiving apparatus 10a-1, as indicated by (8) in FIG. 2.

In this manner, the transmitting and receiving apparatus 10a-1 in the first embodiment confirms that a link has been established between the transmitting and receiving apparatuses 10a-1 and 10b-1 with the optical signal of the wavelength λ5. Then, after confirming the link-establishment, the transmitting and receiving apparatus 10a-1 starts transmission of the optical signal of the wavelength λ5. Here, the transmitting and receiving apparatus 10a-1 continuously sends token data to occupy the wavelength band of λ5. Therefore, upon completion of transmission of all optical signals to be transmitted, the transmitting and receiving apparatus 10a-1 stops token data transmission, deallocating the wavelength band of the wavelength λ5.

[WDM Apparatus]

A detailed configuration of the WDM apparatus 200a explained so far is depicted in FIG. 3. As depicted in FIG. 3, the WDM apparatus 200a first includes the plurality of transmitting and receiving apparatuses 10a-1 to 10a-n. In FIG. 3, for convenience of explanation, only the transmitting and receiving apparatuses 10a-1 and 10a-2 are depicted. Also, as depicted in FIG. 3, the WDM apparatus 200a particularly includes the wavelength multiplexing unit 21a, the wavelength demultiplexing unit 24a, the transmission-wavelength monitoring unit 25a, the reception controlling unit 30a, the wavelength switching unit 29a, and the conversion-wavelength storage unit 50a.

The wavelength multiplexing unit 21a multiplexes optical signals of the wavelengths λ1 to λn input from the transmitting and receiving apparatuses 10a-1 to 10a-n for transmission via the optical fiber cable to the wavelength demultiplexing unit 24b of the WDM apparatus 200b. The wavelength demultiplexing unit 24a demultiplexes the multiplexed optical signal to optical signals of the wavelengths λ1 to λn for output to the transmitting and receiving apparatuses 10a-1 to 10a-n.

The transmission-wavelength monitoring unit 25a monitors the wavelength multiplexing unit 21a to monitor the wavelength of each of the optical signals transmitted by the transmitting and receiving apparatuses 10a-1 to 10a-n. Also, the transmission-wavelength monitoring unit 25a reports the monitored wavelength to the conversion-wavelength storage unit 50a.

The reception controlling unit 30a particularly includes a reception-wavelength monitoring unit 26a, a PORT recognizing unit 27a, and an optical/electrical (O/E) converting unit 28a, as depicted in FIG. 3. The reception-wavelength monitoring unit 26a monitors the wavelength demultiplexing unit 24a to monitor the wavelength of each of the optical signal received by the transmitting and receiving apparatuses 10a-1 to 10a-n. Also, the reception-wavelength monitoring unit 26a reports the monitored wavelength to the conversion-wavelength storage unit 50a.

The PORT recognizing unit 27a performs different operations when receiving normal data, when receiving token data, and when receiving response data.

First, when receiving normal data, the PORT recognizing unit 27a receives from the O/E converting unit 28a data obtained through conversion to an electrical signal by the O/E converting unit 28a, recognizing information about a port of the optical signal received by the wavelength demultiplexing unit 24a. Also, the PORT recognizing unit 27a reports the recognized port information to the wavelength switching unit 29a.

Next, when receiving token data, the PORT recognizing unit 27a receives from the O/E converting unit 28a token data obtained through conversion to an electrical signal by the O/E converting unit 28a, recognizing information about a port and a wavelength included in the token data. Also, the PORT recognizing unit 27a reports the recognized port and wavelength information to the wavelength switching unit 29a.

Next, when receiving response data, the PORT recognizing unit 27a receives from the O/E converting unit 28a response data obtained through conversion to an electrical signal by the O/E converting unit 28a, recognizing information about a port and a wavelength included in the response data. Also, the PORT recognizing unit 27a checks the port information and the wavelength information included in the response data, thereby confirming that a link has been established. Also, upon confirming that a link has been established, the PORT recognizing unit 27a reports as such to the wavelength switching unit 29a.

The O/E converting unit 28a converts an optical signal received by the wavelength demultiplexing unit 24a to an electrical signal for transmission to the PORT recognizing unit 27a.

The wavelength switching unit 29a performs different operations when receiving normal data, when receiving token data, and when receiving response data.

First, when receiving normal data, the wavelength switching unit 29a distributes the optical signal received by the wavelength demultiplexing unit 24a to the transmitting and receiving apparatuses 10a-1 to 10a-n based on the port information reported by the PORT recognizing unit 27a.

Next, when receiving token data, the wavelength switching unit 29a connects to a transmitting and receiving apparatus identified with the port information reported by the PORT recognizing unit 27a with a wavelength identified by the wavelength information reported by the PORT recognizing unit 27a, and then transmits the token data to any one of the conversion-wavelength determining units 14a-1 to 14a-n.

Next, when receiving response data, the wavelength switching unit 29a couples and transmits the confirmation reported by the PORT recognizing unit 27a to a transmitting and receiving apparatus identified by the port information reported by the PORT recognizing unit 27a with a wavelength identified with the wavelength information reported by the PORT recognizing unit 27a.

The conversion-wavelength storage unit 50a has stored therein the wavelengths λ1 to λn and their states indicative of whether the wavelength is currently in use or is currently not used (free wavelength), in association with each other. Also, when the wavelengths are reported by the transmission-wavelength monitoring unit 25a and the reception-wavelength monitoring unit 26a, the conversion-wavelength storage unit 50a searches the reported wavelengths for a free wavelength, and then reports the found free wavelength to the transmitting and receiving apparatuses 10a-1 to 10a-n.

Next, the configuration of each of the transmitting and receiving apparatuses 10a-1 to 10a-n is explained. In the following, the transmitting and receiving apparatus 10a-1 is exemplary explained. As depicted in FIG. 3, the transmitting and receiving apparatus 10a-1 particularly includes an interface (I/F) unit 11a-1, an optical/electrical (O/E) converting unit 12a-1, an idle-pattern discarding unit 13a-1, the conversion-wavelength determining unit 14a-1, a data buffer 15a-1, a transmission controlling unit 16a-1, an electrical/optical (E/O) converting unit 17a-1, an O/E converting unit 18a-1, and an E/O converting unit 19a-1.

The I/F unit 11a-1 is an interface connecting the transmitting and receiving apparatus 10a-1 and the external apparatus not shown together. Also, as depicted in FIG. 3, the I/F unit 11a-1 connects the O/E converting unit 12a-1 and the E/O converting unit 19a-1 together.

The O/E converting unit 12a-1 converts an optical signal to an electrical signal. Also, as depicted in FIG. 3, the O/E converting unit 12a-1 connects to the idle-pattern discarding unit 13a-1. Specifically, the O/E converting unit 12a-1 converts an optical signal received from the I/F unit 11a-1 to an electrical signal for transmission to the idle-pattern discarding unit 13a-1.

The idle-pattern discarding unit 13a-1 discards an idle pattern. Also, as depicted in FIG. 3, the idle-pattern discarding unit 13a-1 connects to the O/E converting unit 12a-1 and the conversion-wavelength determining unit 14a-1. Specifically, when no electrical signal is input from the O/E converting unit 12a-1, the idle-pattern discarding unit 13a-1 discards an idle pattern, thereby stopping optical signal transmission by the transmitting and receiving apparatus 10a-1. Furthermore, when an electrical signal is newly input from the O/E converting unit 12a-1, the idle-pattern discarding unit 13a-1 transmits the electrical signal as it is to the conversion-wavelength determining unit 14a-1.

The conversion-wavelength determining unit 14a-1 determines a wavelength for use when an optical signal is converted in the transmitting and receiving apparatus 10a-1. Also, as depicted in FIG. 3, the conversion-wavelength determining unit 14a-1 connects to the idle-pattern discarding unit 13a-1, the data buffer 15a-1, and the conversion-wavelength storage unit 50a.

Specifically, upon receiving the electrical signal from the idle-pattern discarding unit 13a-1, the conversion-wavelength determining unit 14a-1 stores the electrical signal in the data buffer 15a-1. Also, upon receiving a newly input signal from the idle-pattern discarding unit 13a-1 after optical signal transmission is once stopped by the idle-pattern discarding unit 13a-1, the conversion-wavelength determining unit 14a-1 obtains a free wavelength from the conversion-wavelength storage unit 50a. Furthermore, upon receiving the free wavelength from the conversion-wavelength storage unit 50a, the conversion-wavelength determining unit 14a-1 sets the obtained wavelength to the E/O converting unit 17a-1 as a wavelength for converting the electrical signal stored in the data buffer 15a-1. Still further, upon obtaining the free wavelength from the conversion-wavelength storage unit 50a, the conversion-wavelength determining unit 14a-1 generates token data and starts transmission.

Still further, upon receiving token data from the wavelength switching unit 29a, the conversion-wavelength determining unit 14a-1 generates response data for transmission.

The data buffer 15a-1 has stored therein an electrical signal received by the transmitting and receiving apparatus 10a-1 from the external apparatus. Also, as depicted in FIG. 3, the data buffer 15a-1 connects to the conversion-wavelength determining unit 14a-1 and the transmission controlling unit 16a-1. Specifically, the data buffer 15a-1 stores an electrical signal transmitted from the conversion-wavelength determining unit 14a-1. Here, the electrical signal stored in the data buffer 15a-1 is read and transmitted by being controlled by the transmission controlling unit 16a-1. Also, the electrical signal stored in the data buffer 15a-1 is converted by the E/O converting unit 17a-1 to an optical signal of the wavelength set by the conversion-wavelength determining unit 14a-1 for transmission.

The transmission controlling unit 16a-1 controls optical signal transmission. Also, as depicted in FIG. 3, the transmission controlling unit 16a-1 connects to the data buffer 15a-1 and the E/O converting unit 17a-1. Specifically, the transmission controlling unit 16a-1 reads the electrical signal stored in the data buffer 15a-1 for transmission.

The E/O converting unit 17a-1 converts an electrical signal to an optical signal. Specifically, the E/O converting unit 17a-1 converts the electrical signal read from the data buffer 15a-1 by being controlled by the transmission controlling unit 16a-1 to an optical signal of the wavelength set by the conversion-wavelength determining unit 14a-1 for transmission.

The O/E converting unit 18a-1 converts an optical signal to an electrical signal. Also, as depicted in FIG. 3, the O/E converting unit 18a-1 connects to the wavelength switching unit 29a and the E/O converting unit 19a-1. Specifically, the O/E converting unit 18a-1 converts the optical signal received from the wavelength switching unit 29a to an electrical signal for transmission to the E/O converting unit 19a-1.

The E/O converting unit 19a-1 converts an electrical signal to an optical signal. Also, as depicted in FIG. 3, the E/O converting unit 19a-1 connects to the O/E converting unit 18a-1 and the I/F unit 11a-1. Specifically, the E/O converting unit 19a-1 converts the electrical signal received from the O/E converting unit 18a-1 to an optical signal for transmission to the I/F unit 11a-1.

Note that, as depicted in FIG. 4, the WDM apparatus 200b has a configuration similar to that of the WDM apparatus 200a.

### Procedure of the Process by the WDM System in the First Embodiment

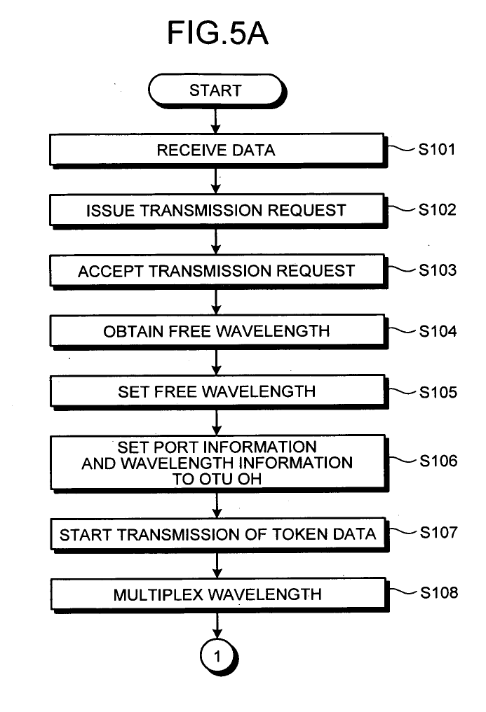

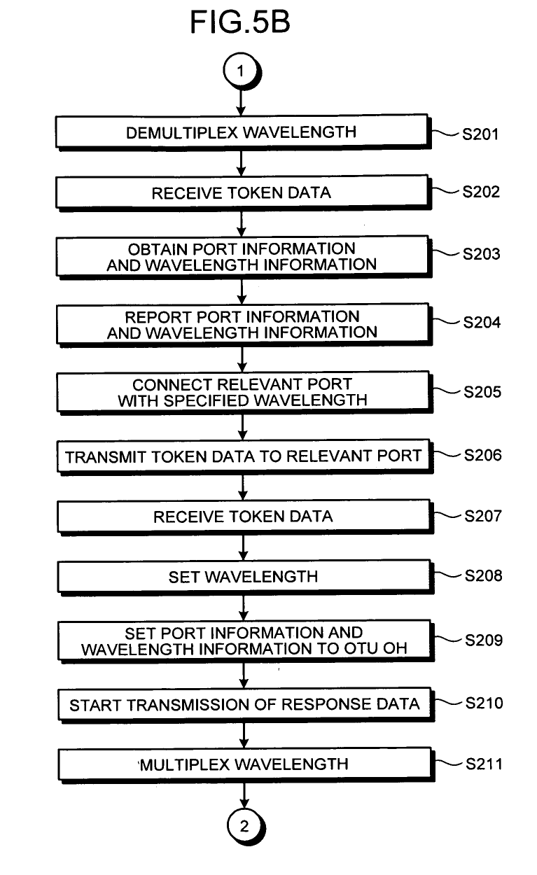

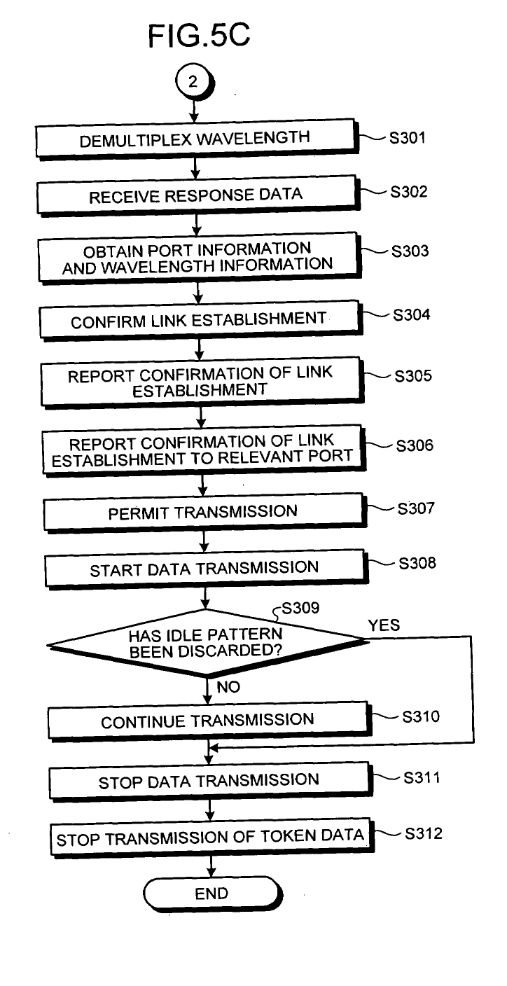

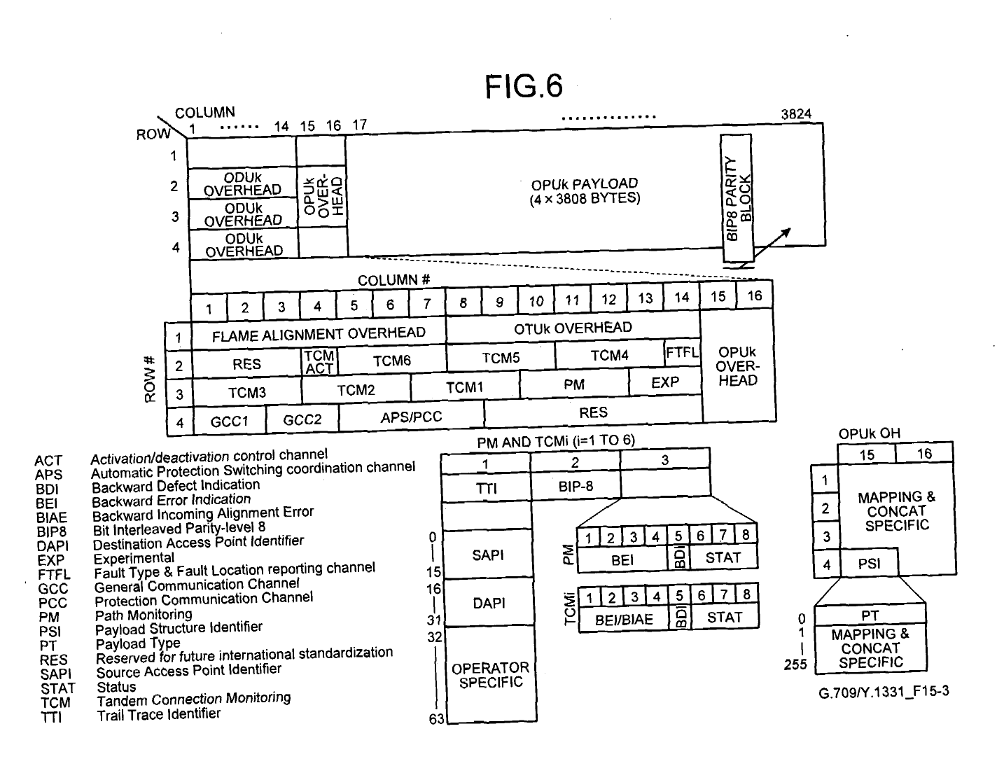

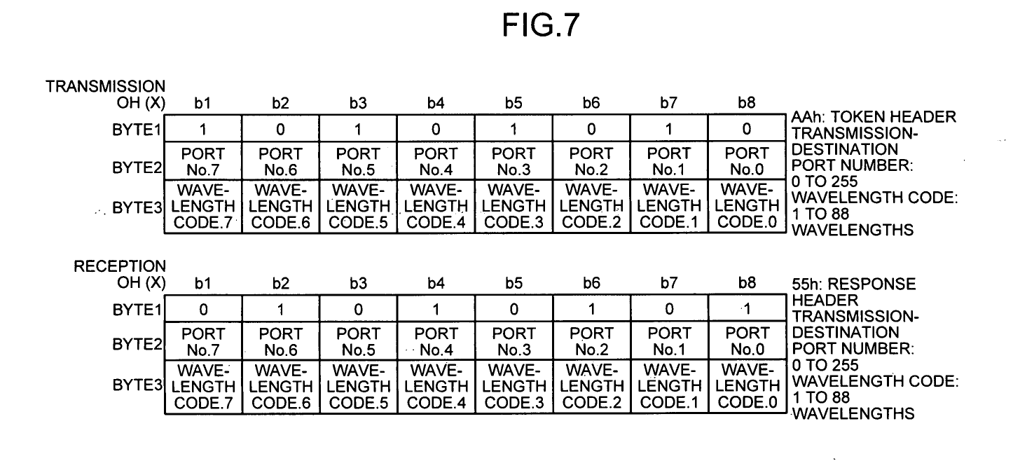

Next, the procedure of a process by the WDM system in the first embodiment is explained by using FIGS. 5A to 5C, 6, and 7. FIGS. 5A to 5C are flowcharts of a procedure of a process of the WDM system in the first embodiment. FIGS. 6 and 7 are drawings for explaining token data and response data.

FIG. 5A is flowchart of a procedure of a process in the WDM apparatus 200a. As required, the transmitting and receiving apparatus 10a-1 is taken as an example. FIG. 5B is a flowchart of the procedure of the process in the WDM apparatus 200a. As required, the transmitting and receiving apparatus 10b-1 is taken as an example. Also, FIGS. 5A to 5C depict the procedure of processes continuously performed between the WDM apparatus 200a and the WDM apparatus 200b.

The procedure depicted in FIG. 5A is explained. First, it is assumed that the transmitting and receiving apparatus 10a-1 of the WDM apparatus 200a receives data from an external apparatus not shown (step S101). Note that this data is newly received after an idle pattern is discarded in the idle-pattern discarding unit 13a-1 of the transmitting and receiving apparatus 10a-1. Then, the data is converted from an optical signal to an electrical signal by the O/E converting unit 12a-1. Also, the data goes through the idle-pattern discarding unit 13a-1 and the conversion-wavelength determining unit 14-1a to be stored in the data buffer 15a-1.

When the data is stored, the data buffer 15a-1 issues a transmission request (step S102). Then, the transmission controlling unit 16a-1 accepts the transmission request issued by the data buffer 15a-1 (step S103).

On the other hand, in the transmitting and receiving apparatus 10a-1, the conversion-wavelength determining unit 14a-1 obtains a free wavelength from the conversion-wavelength storage unit 50a (step S104). Then, the conversion-wavelength determining unit 14a-1 determines the obtained free wavelength as a wavelength for use when an optical signal is converted in the transmitting and receiving apparatus 10a-1, and sets the wavelength to the E/O converting unit 17a-1 (step S105).

Furthermore, the conversion-wavelength determining unit 14a-1 sets the port information and the wavelength information in a free Overhead (OH) of an Optical Channel Transport Unit (OTU) (step S106). For example, in a free OH “RES” of an OTU frame depicted in FIG. 6, the conversion-wavelength determining unit 14a-1 sets the port information and the wavelength information, as depicted in FIG. 7.

Here, “RES” can be set with information of three bytes, as depicted in FIG. 6. Therefore, for example, as depicted in FIG. 7, the conversion-wavelength determining unit 14a-1 uses one byte to set a code for identifying token data or response data (“AAh” or “55h”). Also, as depicted in FIG. 7, the conversion-wavelength determining unit 14a-1 uses one byte to set a port number (“0” to “225”). Furthermore, as depicted in FIG. 7, the conversion-wavelength determining unit 14a-1 uses one byte to set a wavelength code (“1” to “88”).

Then, the conversion-wavelength determining unit 14a-1 starts transmission of token data (step S107). The transmitted token data is wavelength-multiplexed by the wavelength multiplexing unit 21a, and is then transmitted to the counterpart wavelength multiplexing transmitting apparatus 200b (step S108).

Next, the procedure depicted in FIG. 5B is explained. First, in the WDM apparatus 200b, the wavelength demultiplexing unit 24b demultiplexes the wavelength (step S201). Then, an O/E converting unit 28b converts an optical signal to an electrical signal, and then a PORT recognizing unit 27b receives token data (step S202).

The PORT recognizing unit 27b obtains port information and wavelength information from the received token data (step S203). The PORT recognizing unit 27b then reports the obtained port information and wavelength information to the wavelength switching unit 29b (step S204).

Then, the wavelength switching unit 29b connects to the transmitting and receiving apparatus 10b-1 identified with the reported portion information with the optical signal of the wavelength identified with the reported wavelength information (step S205), thereby transmitting token data (step S206).

On the other hand, a conversion-wavelength determining unit 14b-1 of the transmitting and receiving apparatus 10b-1 receives the token data (step S207). The conversion-wavelength determining unit 14b-1 sets a wavelength to an E/O converting unit 17b-1 based on the received token data (step S208). Furthermore, the conversion-wavelength determining unit 14b-1 sets the port information and the wavelength information in a free OH of an OTU frame (step S209). For example, in the free OH “RES” of the OTU frame depicted in FIG. 6, the conversion-wavelength determining unit 14b-1 sets the port information and the wavelength information, as depicted in FIG. 7.

Then, the conversion-wavelength determining unit 14b-1 starts transmission of response data (step S210). The transmitted response data is wavelength-multiplexed by the wavelength multiplexing unit 21b for transmission to the counterpart WDM apparatus 200a (step S211).

Next, the procedure depicted in FIG. 5C is explained. First, in the WDM apparatus 200a, the wavelength demultiplexing unit 24a demultiplexes the wavelength (step S301). Then, the O/E converting unit 28a converts an optical signal to an electrical signal, and then the PORT recognizing unit 27a receives response data (step S302).

The PORT recognizing unit 27a obtains port information and wavelength information from the received response data (step S303). The PORT recognizing unit 27a then confirms from the obtained port information and wavelength information that a link has been established between the WDM apparatuses 200a and 200b (step S304), and then reports as such to the wavelength switching unit 29a (step S305).

Then, the wavelength switching unit 29a reports to the transmitting and receiving apparatus 10a-1 identified with the reported port information that a link has been established (step S306).

On the other hand, the transmission controlling unit 16a-1 of the transmitting and receiving apparatus 10a-1 receives the confirmation that a link has been established. Then, the transmission controlling unit 16a-1 issues a permission for transmission to the data buffer 15a-1 (step S307), starting data transmission (step S308).

Thereafter, the transmitting and receiving apparatus 10a-1 determines whether an idle pattern has been discarded by the idle-pattern discarding unit 13a-1 (step S309). As long as discard does not occur (“No” at step S309), the transmission by the transmission controlling unit 16a-1 continues (step S310). If discard occurs (“Yes” at step S309), the data transmission by the he transmission controlling unit 16a-1 is stopped (step S311) and transmission of the token data by the conversion-wavelength determining unit 14a-1 is also stopped (step S312), deallocating the used wavelength band.

### Effects of the First Embodiment

As has been explained above, according to the first embodiment, the WDM apparatus monitors the wavelength of each optical signal to be transmitted from a plurality of transmitting and receiving apparatuses, and determines an unused free wavelength currently not in use by any of the transmitting and receiving apparatuses. Also, the WDM apparatus monitors the wavelength of each optical signal to be received by the transmitting and receiving apparatuses, and determines an unused free wavelength currently not in use by any of the transmitting and receiving apparatuses. When no signal to be transmitted to the transmission-destination apparatus is input, the transmitting and receiving apparatuses each discard an idle pattern to stop optical signal transmission. Also, when optical signal transmission is stopped and is then restarted with a newly input signal, the transmitting and receiving apparatuses each obtain the determined free wavelength. The transmitting and receiving apparatuses each convert a signal to be transmitted to the transmission-destination apparatus to an optical signal of the wavelength determined as a free wavelength in both of transmitting and receiving directions, and then transmits the optical signal to the transmission-destination apparatus.

From above, according to the first embodiment, a single transmitting and receiving apparatus can flexibly support a plurality of wavelengths. In other words, according to the first embodiment, a single transmitting and receiving apparatus can transmit an optical signal to a plurality of transmitting and receiving apparatuses in a restricted wavelength band. Furthermore, according to the first embodiment, a predetermined wavelength is not fixedly set to a transmitting and receiving apparatus. Therefore, a transmitting and receiving apparatus that supports more than the number of wavelengths can be connected. Still further, according to the first embodiment, a signal is converted to an optical signal of a wavelength determined as a free wavelength in both directions. Therefore, it is possible to support the case in which an optical module on a transmission side and an optical module on a reception side are integrated together.

Still further, according to the first embodiment, the transmitting and receiving apparatuses each transmit to the transmission-destination apparatus token data reporting that an optical signal of a free wavelength is to be transmitted. Also, the transmitting and receiving apparatuses each receives response data for the transmitted token data from the transmission-destination apparatus. Furthermore, on condition that the received response data is a normal response (a link has been established), the transmitting and receiving apparatuses each convert the signal to be transmitted to the transmission-destination apparatus to an optical signal of a free wavelength for transmission. With this, according to the first embodiment, an optical signal is transmitted upon confirmation that a link has been established. Therefore, communication can be reliably performed.

### Second Embodiment

### Other Embodiments

While the embodiment of the present invention has been explained, the present invention can be implemented in various embodiments other than the embodiment.

In the first embodiment, the WDM apparatuses 200a and 200b have similar functions and configuration. However, the present invention is not meant to be restricted to this. For example, the present invention can be similarly applied to the case in which the WDM apparatus 200a has only the functions as a transmission side and the WDM apparatus 200b has only the functions as a reception side. In this case, the transmitting and receiving apparatuses each function as a transmitting apparatus and a receiving apparatus.

Also, in the first embodiment, the WDM apparatuses 200a and 200b transmit and receive token data and response data to establish a link, and restart data transmission upon confirming that a link has been established. However, the present invention is not meant to be restricted to this. The WDM apparatus 200a on a transmission side may not transmit token data. In this case, no response data is received. That is, after obtaining a free wavelength and without confirming link establishment, the WDM apparatus 200a on a transmission side may convert a signal to an optical signal with the obtained free wavelength.

Furthermore, in the first embodiment, it is assumed that the optical module for transmission and the optical module for reception are integrated together, and the WDM apparatus 200a on the transmission side uses a free wavelength that is free in both transmitting and receiving directions. However, the present invention is not meant to be restricted to this. That is, when the optical module for transmission and the optical module for reception are not integrated together, the WDM apparatus 200a may obtain only a free wavelength in the transmitting direction and convert a signal to an optical signal of the obtained free wavelength.

[System Configuration and Others]

Still further, among the processes explained in the embodiments above, all or part of the processes explained as being automatically performed may be manually performed, or all or part of the processes explained as being manually performed may be automatically performed through a known method. In addition, the process procedure (for example, FIGS. 5A to 5C), the control procedure, specific names, and information including various signals and parameters explained in the specification and depicted in the drawings can be arbitrarily changed unless otherwise specified.

For example, in the first embodiment, the technique is explained in which the conversion-wavelength storage unit 50a uses the wavelength information received from the transmission-wavelength monitoring unit 25a and the wavelength information received from the reception controlling unit 30a to search for a free wavelength common in both directions. However, the present invention is not meant to be restricted to this. Alternatively, for example, the conversion-wavelength determining unit 14a-1 may obtain two pieces of wavelength information from the conversion-wavelength storage unit 50a to determine by itself a free wavelength. In addition, the process performed in each unit may be performed in another unit as appropriate.

Still further, each component depicted is conceptual in function, and is not necessarily physically configured as depicted (for example, in FIGS. 3 and 4). That is, the specific patterns of distribution and unification of the components are not meant to be restricted to those depicted in the drawings. All or part of the components can be functionally or physically distributed or unified in arbitrary units according to various loads and the state of use.

Still further, all or arbitrary part of the process functions performed in each component can be achieved by a Central Processing Unit (CPU) and a program analyzed and executed on that CPU, or can be achieved as hardware with a wired logic.

According to the embodiments, a single transmitting and receiving apparatus can flexibly support a plurality of wavelengths.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An optical transmitting apparatus including a plurality of transmitting apparatuses that each converts an external signal to an optical signal of a predetermined wavelength to be transmitted to a receiving apparatus, the optical transmitting apparatus comprising:
an unused-wavelength determining unit that monitors the wavelength of the optical signal transmitted by each of the transmitting apparatuses to determine an unused wavelength currently not in use by any-of the-transmitting apparatuses, and
each of the transmitting apparatuses comprising:
a stopping unit that stops transmitting the optical signal when no signal to be transmitted to the receiving apparatus is input;
an unused-wavelength obtaining unit that obtains the unused wavelength determined by the unused-wavelength determining unit, after the optical signal transmission is stopped by the stopping unit and is then restarted with a newly input external signal; and
a transmitting unit that converts the new external signal to an optical signal of the unused wavelength obtained by the unused-wavelength obtaining unit to transmit the optical signal to the receiving apparatus.

2. The optical transmitting apparatus according to claim 1, wherein
each of the transmitting apparatuses further comprises:
a wavelength-report transmitting unit that transmits to the receiving apparatus a wavelength report indicating that the optical signal of the unused wavelength obtained by the unused-wavelength obtaining unit is to be transmitted; and
a response receiving unit that receives from the receiving apparatus a response to the wavelength report transmitted by the wavelength-report transmitting unit, and
the transmitting unit converts the external signal to the optical signal of the unused wavelength obtained by the unused-wavelength obtaining unit to transmit the optical signal to the receiving apparatus, on condition that the response received by the response receiving unit is a normal response.

3. An optical transmitting and receiving apparatus including a plurality of transmitting and receiving apparatuses that each convert a signal to be transmitted to a transmission-destination apparatus to an optical signal of a predetermined wavelength for transmission to the transmission-destination apparatus, the optical transmitting and receiving apparatus comprising:
a transmission unused-wavelength determining unit that monitors the wavelength of the optical signal transmitted by each of the transmitting and receiving apparatuses to determine an unused wavelength currently not in use by any of the transmitting and receiving apparatuses; and
a reception unused-wavelength determining unit that monitors a wavelength of an optical signal received by the transmitting and receiving apparatuses to determine an unused wavelength currently not in use by any of the transmitting and receiving apparatuses,
each of the transmitting and receiving apparatuses comprising:
a stopping unit that stops transmitting the optical signal when no signal to be transmitted to the transmission-destination apparatus is input;
an unused-wavelength obtaining unit that obtains the unused wavelength determined by the transmission unused-wavelength determining unit and the unused wavelength determined by the reception unused-wavelength determining unit, after the optical signal transmission is stopped by the stopping unit and is then restarted with a newly input signal; and
a transmitting unit that converts the signal to be transmitted to the transmission-destination apparatus to an optical signal of a wavelength, determined by both of the transmission unused-wavelength determining unit and the reception unused-wavelength determining unit as the unused wavelength from among the used wavelengths obtained by the unused-wavelength obtaining unit, to transmit the optical signal to the receiving apparatus.
